(19) United States
(12) Patent Application Publication
(10) Pub. No.: US 2025/0053959 A1
(43) Pub. Date: Feb. 13, 2025

(54) TRANSACTIONS WITH SERVICE RAIL CONVERSION

(71) Applicant: Wells Fargo Bank, N.A., San Francisco, CA (US)

(72) Inventors: Jenny Yee Tao, Belmont, CA (US); Eric J. Miller, Minneapolis, MN (US); Young M. Yang, San Francisco, CA (US)

(21) Appl. No.: 18/366,483

(22) Filed: Aug. 7, 2023

(51) Int. Cl. G06Q 20/36; G06Q 20/02

(52) U.S. Cl. CPC G06Q 20/36; G06Q 20/023

(57) ABSTRACT

Systems and methods may generally be used for processing transactions. An example method may include receiving a request from a wallet application to perform a transaction to transfer funds from a payor account over a first payment rail. The first payment rail may be associate with a payment network corresponding with an element of the wallet application. The example method may include determining whether a second payment rail is available for processing the request based upon a determination that the second payment rail meets a requirement of the transaction. The example method may further include, upon determining that the second payment rail is available, converting the request to a request for processing using a second payment rail different from the first payment rail, and processing the request using the second payment rail.

### BACKGROUND

Today, many customers use debit cards instead of cash to make purchases. The fees associated with conducting such transactions and processing associated payments may be significant. Accordingly, there is a general need for the financial services industry to move money in a way that may perform transactions with minimized expense.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a system in which example embodiments may be performed.

FIG. 2 illustrates a flowchart of a method for processing a transaction in accordance with some embodiments.

FIG. 3 illustrates machine learning engine for training and execution in accordance with some embodiments.

FIG. 4 illustrates generally an example of a block diagram of a machine upon which any one or more of the techniques discussed herein may perform in accordance with some embodiments.

### DETAILED DESCRIPTION

Systems and techniques described herein may be used to reduce costs associated with traversal of data across multiple processing networks and links. Systems and techniques can facilitate or implement payment transactions between a customer and a merchant (either online or at a point of sale) or between a customer and service provider who takes regular payments from a customer (e.g., bill payment providers, mortgage providers, etc.). In similar transactions today, debit cards may be used that are tied to a customer's banking account (e.g., checking account). A merchant or provider may pay discount fees to the merchant's financial institution processor to cover the cost of processing and interchange fees to the card issuer and the card network for accepting cards. For example, when a customer purchases an item from a merchant using a debit card, the merchant captures and logs the transaction and sends the transaction to a merchant processor. From there, the transaction is routed to the appropriate card network, where a transaction processing fee is charged. Other fees, as well as delays, may accrue, resulting in significant expense to merchants. This may be especially detrimental for smaller merchants who cannot easily absorb these costs and who are not large enough to negotiate lower fees.

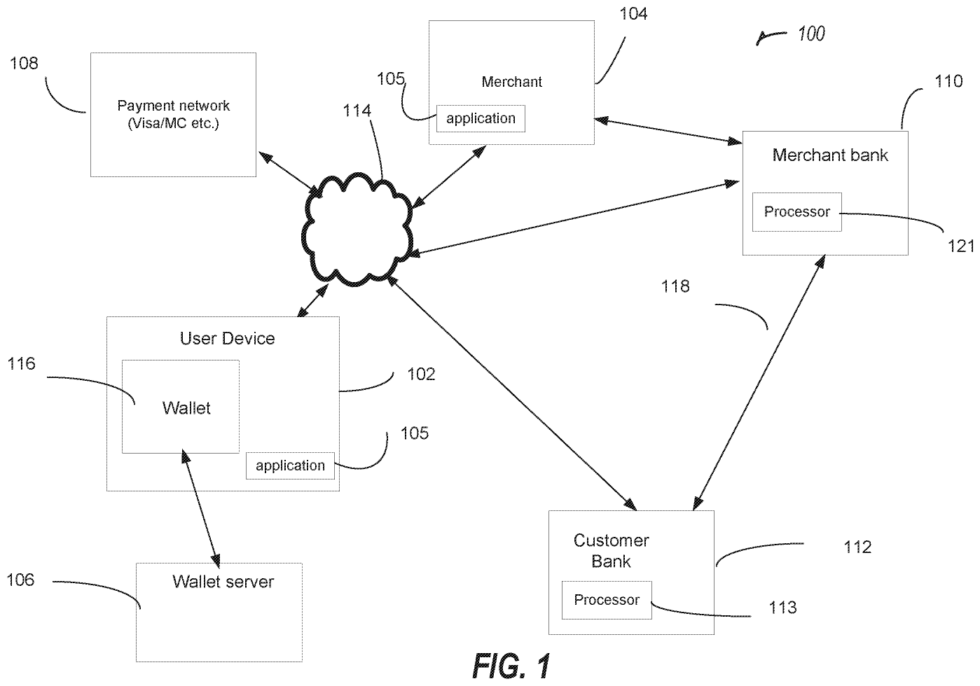

These and other concerns are addressed using systems and techniques to perform transactions using less expensive payment rails, allowing the financial service industry to reduce costs with little or minimal effect on level of service. Systems and techniques described herein may be advertised as a service to potential merchant clients of a financial institution. Furthermore, incentives may be provided to customers to take advantage of the systems and techniques described herein. Both of these scenarios and possibilities may increase the financial institution's customer base and number and size of deposit accounts, improving the financial institution's profitability. FIG. 1 illustrates an environment 100 in which example embodiments can be implemented. The environment 100 includes a user device 102, a merchant 104, wallet server 106, payment network 108, a merchant bank 110, a customer bank 112, and communication network 114.

The user device 102 can include a smartphone or other mobile device, laptop, desktop, etc. The user device 102 can include a wallet 116 (e.g., a digital wallet) as an application program that runs on the user device 102. The wallet 116 allows an individual to make electronic commerce transactions, which may include purchasing items and making payments. Exemplary wallets are Wells Fargo Wallet®, Apple Pay®, Google Wallet®, PayPal®, Samsung Pay®, and Starbucks App®. The wallet includes one or more of payment elements (not shown) such as a credit card, a debit card, and a bank account. The user may log in to a “pay with wallet” step in an online transaction with a merchant website. Alternatively, if the user is at a brick-and-mortar store, the user may select a payment element in the wallet 116 and tap the mobile device or bring it within near field communication (NFC) range of the point-of-sale (POS) terminal.

The wallet 116 issuer can provide services associated with the digital wallet 116 using computing applications of the wallet server 106. The wallet server 106 can store application code for the digital wallet 116 and user information such as payment and shipping information. When a wallet server 106 is used, the user device 102 may store only a “thin” client application that communicates with the wallet server 106 when the wallet 116 is used to make a purchase. The wallet server 106 then acts as a proxy to send payment information and otherwise communicate with the merchant 104.

The digital wallet 116 issuer can be an issuer (e.g., a financial institution) of the payment elements in the digital wallet 116. Wells Fargo® is an example of such an organization which provides both the digital wallet 116 and payment elements that are used in the digital wallet 116. An example of a digital wallet application is Wells Fargo Wallet®. In an embodiment, the digital wallet 116 provider is different from the issuer. Apple® is a digital wallet provider of Apple Pay® and the payment elements in Apple Pay® may be issued by banks for instance. In this embodiment, the digital wallet 116 provider serves as a bridge between the digital wallet 116 and the issuer accessed via the web browser. The user device 102 can have an associated customer bank 112 that holds deposit accounts, credit accounts, etc. of the associated user of the user device 102 or of another party related to the user of the user device 102. The customer bank 112 can include processing circuitry 113 for predicting user preferences regarding payment rails as escribed below.

The merchant 104 can have an application 105 associated therewith, which can be downloaded by the user device 102 or otherwise available for access by the user device 102. For instance, a shopping application may be downloaded to the user device 102 and the online merchant that provides the shopping application may be the merchant 104. The digital wallet 116 may communicate with the merchant 104 using the merchant application or using or more ecommerce transaction protocols. The merchant 104 can have an associated merchant bank 120 that holds deposits and other accounts for the merchant 104. The merchant bank 120 can include a processor 121 for processing related to payment rails and changing payment rails as described below.

The communication network 114 can include or be comprised of one or more communication media or methods that provide communication between entities 102, 104, 108, 112 or other elements not shown in FIG. 1 capable of communication over a wired or wireless connection. The communication network 114 may include the Internet, a mobile network, a local area network, a home network, a wired (e.g., Ethernet) connection, a personal area network, a Wi-Fi® network, a Bluetooth® connection, or others.

The environment 100 can include a payment network 108. The payment network 108 can include at least two components. A first component can comprise a seller or merchant access network that provides connection to POS devices or other merchant 104 internal networks (e.g., directly or via merchant internal networks or online storefronts) and identification of the type of payment account (e.g., Visa® or MasterCard®).

A second component can include payment processing networks to process payment instructions based on established agreements by parties participating in the processing of payment. Some example payment processing networks include networks provided by VISA® and MASTERCARD® or the banks associated issuing banks. In any given transaction, the operator of an association network controls the flow of funds for the transaction and typically passes along a fee to the merchant (which in some instances as described above can be still further passed along to the customer).

In a typical interaction, the user device 102 may use wallet-based pay options used through websites (e.g., Pay with Amazon, PayPal, Early Warning Services (EWS) Wallet). During a finalization or “checkout” process, in some implementations and with some providers, the customer may enter contact information or confirmation codes, etc. that triggers payment information to be sent to the merchant's point of sale system. In most systems used today, payment is accomplished using debit or credit payment rails. In the context of embodiments, a payment rail is a platform or network infrastructure that allows digital money transfers to be made between payers and payees. Payment rails may operate regardless of country, currency, method, type of payee, type of payor, etc. Payment rails may differ in various features, including cost, speed, payment type, technology, etc. Some example payment rails include automated clearing house (ACH), PayPal, Real-Time Payments (RTP), blockchain, Society for Worldwide Interbank Financial Telecommunication (SWIFT) and single euro payments area (SEPA), as well as card rails associated with, for example, MASTERCARD and VISA.

As described above, one shortcoming of debit payments over the payment network is the relatively high fee that is incurred. These fees are incurred by the merchant and may be passed on to the customer, resulting in reduced satisfaction and inconvenience. Different payment rails could be considered that would avoid or minimize these fees. For example, the ACH process or payment rail may be cheaper to process as transactions do not need to go through the card network for processing, eliminating reduce costs associated with traversal of data across multiple processing networks and links and other costs associated with debit card processing. In other words, an ACH payment would go directly from the customer's account to the merchant's account. However, it may be against payment network rules or terms of service to change a credit/debit transaction to an ACH to save on the network fees once a transaction hits the network. For example, once a credit card or debit card transaction is initiated through a merchant point-of-sale system, it may be against the specific payment network rules to convert the card transaction into an ACH transaction to avoid associated network fees.

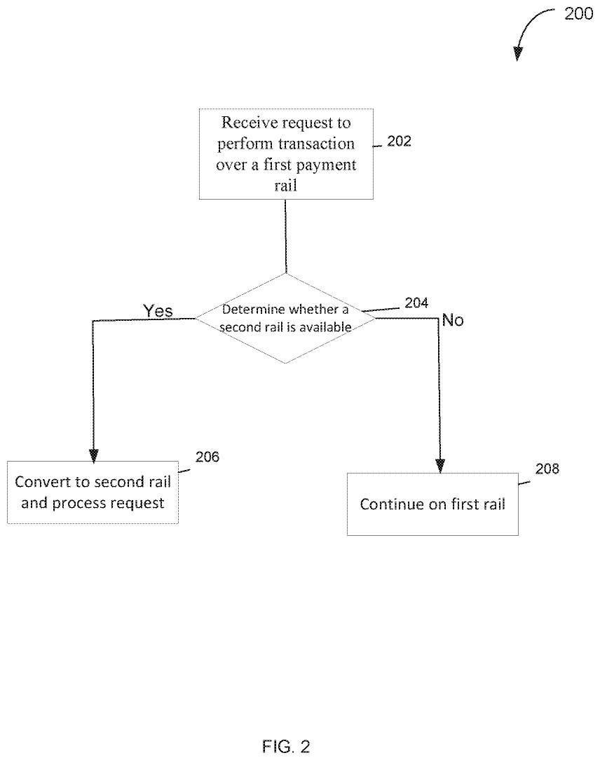

Systems and methods according to embodiments, however, may use features of payment wallets to “catch” transactions before the transactions reach the network 108. This makes those transactions eligible to be routed to ACH (or other payment rails 118, directly between the customer bank 112 and the merchant bank 120) to reduce or eliminate costs. Customers will be asked for consent before transactions are routed, whether by setting up authorization in a user profile or during account set up, or at the point of sale (merchant website or bricks and mortar location) using an authorization method. For example, the user may log in to a “pay with wallet” step of an online transaction. FIG. 2 illustrates a flowchart showing a method 200 for processing a transaction in accordance with some embodiments.

The method 200 may be implemented by the user device 102, by a wallet 116 associated with the user device 102, or by a wallet server 106 associated with the wallet 116 or customer bank or component or processor thereof, using connections 114 to either or both of the merchant 104, customer bank 112, merchant bank 110, or devices thereof. The method 200 may begin with operation 202 with the wallet 116 or wallet server 106 receiving (over connection/s 114) a request to perform a transaction to transfer funds from a payor account over a first payment rail (e.g., over the payment network 108). Operation 202 may occur, for example, when a customer initiates a transaction with a merchant 104 in a merchant's store, on a website, etc. In some examples, the first payment rail is associated with a debit card/credit card, wherein the debit card/credit card is an element of the wallet 116 and the transaction if allowed to continue would continue over the payment network 108. The operation 202 can be initiated when the customer/user initiates a transaction using the digital wallet 116 application, either online at the merchant 104 online storefront or at a point of sale in some examples.

The method 200 may continue with operation 204 with the wallet server 106 determining whether a second payment rail 118 is available for processing the request. The second payment rail will typically incur reduced processing costs relative to the first payment rail. In examples, the second payment rail includes ACH although embodiments are not limited thereto. As described earlier, ACH incurs reduced financial network fees relative to a typical first payment rail (e.g., debit card rails). The second payment rail may be available, for example, upon approval of its usage by the customer using the user device 102. For example, a message may be displayed requesting authorization to use the second payment rail 118, or the user may have a customer profile that authorizes use of the second payment rail 118. The second payment rail may be available if, for example, an ACH transaction or other second payment rail 118 transaction meets (e.g., can be performed or completed within) timing requirements of the merchant 104, merchant bank 120, etc.

Upon determining that the second payment rail is available, the method 200 may continue with operation 206 with the merchant 104 converting the original transfer request to a request for processing using the second payment rail 118 (e.g., ACH although embodiments are not limited thereto). In examples, the merchant 104 or merchant acquirer would have access to multiple payment rails, enabling the merchant to perform these conversions. The conversion can be performed by the wallet server 106 or component or application of the customer bank 112 (e.g., processing circuitry 113) or the merchant bank 120 (e.g., processor 121). Once converted, processing of the request may continue using the second payment rail 118. Otherwise, if the first payment rail must be used (or if the first payment rail is preferred by either the customer or the merchant 104), processing may continue on the first payment rail without conversion at operation 208. For example, processing may continue over the payment network 108.

In many examples, the initial (original) request includes a request to process the transaction using a debit card system payment rail. Typically, the debit card involved in the request is connected to a financial institution deposit account associated with the payor (or group of payors such as partners (personal and financial), children, and beneficiaries of the main payor). In this manner, the debit card is associated with a direct deposit account associated with the payor account, and funds for performing the payment or other transaction are intended to be drawn from this account. Because of this association, determining whether the second payment rail is available for processing the request will often include determining identification information for account holders of this direct deposit account. Furthermore, availability of the second payment rail includes determining or predicting whether there are or will be sufficient available funds in the deposit account. Included in this determination are predictions of upcoming (e.g., subsequent) deposit dates and deposit amounts.

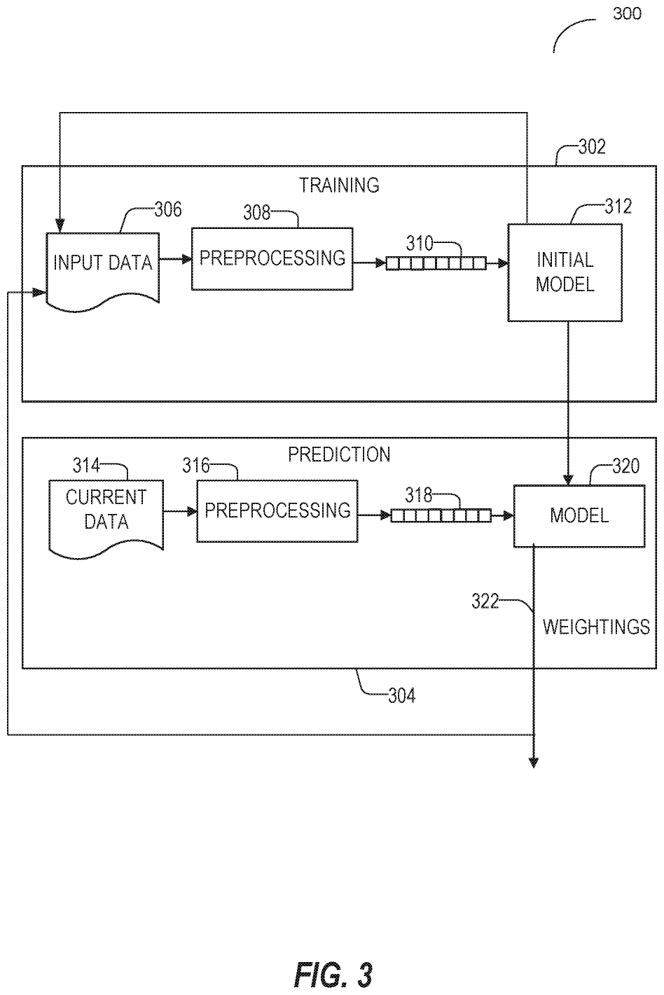

To perform these predictions, the wallet server 106 or software implemented on the processing circuitry 113 may store a model (e.g., a machine learning trained model described later herein with respect to FIG. 3), account history information, or historical information related to payors/customers/co-payors associated with the account. The wallet server 106 may retrieve the model or other data from a database (not shown in FIG. 1) to use in providing recommendations for interaction.

FIG. 3 illustrates a machine learning engine 300 for training and execution in accordance with some embodiments. The machine learning engine 300 may be deployed to execute at the wallet server 106, the processing circuitry 113 or the processor 121. A system may perform NLP using the machine learning engine 300.

Machine learning engine 300 uses a training engine 302 and a prediction engine 304. Training engine 302 uses input data 306, for example after undergoing preprocessing component 308, to determine one or more features 310. The one or more features 310 may be used to generate an initial model 312, which may be updated iteratively or with future labeled or unlabeled data (e.g., during reinforcement learning).

The input data 306 may include biographical information of the a customer associated with the user device 102, historical data related to customer accounts, customer preferences regarding what payment rails should be used, recurring payment history, and spending trends. In the prediction engine 304, current data 314 may be input to preprocessing component 316. In some examples, preprocessing component 316 and preprocessing component 308 are the same. The prediction/reaction engine 304 produces feature vector 318 from the preprocessed current data, which is input into the model 320 to generate one or more criteria weightings 322. The criteria weightings 322 may be used to output a prediction, as discussed further below.

The training engine 302 may operate in an offline manner to train the model 320 (e.g., on a server). The prediction/reaction engine 304 may be designed to operate in an online manner (e.g., in real-time). In some examples, the model 320 may be periodically updated via additional training (e.g., via updated input data 306 or based on data output in the weightings 322) or based on identified future data, such as by using reinforcement learning to personalize a general model (e.g., the initial model 312) to a particular user. In some examples, the training engine 302 may use a trend analysis over time, for example with a user selected or a model identified range.

The initial model 312 may be updated using further input data 306 until a satisfactory model 320 is generated. The model 320 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 302 may be selected from among many different potential supervised or unsupervised machine learning algorithms, including commercial algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 302. In an example embodiment, a regression model is used and the model 320 is a vector of coefficients corresponding to a learned importance for each of the features in the vector of features 310, 318. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 320 may be able to predict whether sufficient funds will be available in an account to perform ACH transfers. Because ACH transfers take longer than debit or other payment rail transfers, the time lag may result in overdrafts in the deposit account, and accordingly predictions of available funds become more important. These predictions may be made based spending patterns to determine whether a user will run out of funds before an ACH payment clears.

Other predictions may include whether a payor is likely to prefer second payment rail transfers over debit rail transfers. In some cases and for some types of purchases, debit rail payments may be optimal for charges unlikely to be returned or disputed. In examples the likelihood may be price-based or based on the difficulty or impossibility of returning items. If the likelihood of return is high, or disputes regarding payments are likely, then second payment rail transfers may not be recommended or conducted. Therefore, by detecting spending and account balance trends, the wallet server 106 or systems provided at the customer bank 112 or the merchant bank 120 in FIG. 1 may predict future actions of the customer as described in FIG. 1 and may provide initial guesses or recommendations for performing transactions with the merchant 104 as described in FIG. 1.

Referring again to FIG. 1, the processor 108 may provide a user interface request to request approval from a payor associated with the payor account to use the second payment rail. This request can also be provided as part of operation 202 (FIG. 2). Upon receiving approval from the payor, the processor 108 may process the request using the second payment rail. Incentives, promotions, rewards, and discounts may be provided on behalf of the payee when the payor approves use of the second payment rail (e.g., ACH). In some examples, approval may be requested from the payee (e.g., merchant 104) as well. For example, the merchant 104, being a customer of the financial institution implementing method 200, may have been offered the opportunity to subscribe to a service that implements method 200, to save money on debit card transaction fees. In some examples, when the payor registers a new wallet account (e.g., a digital wallet) with the financial institution, the payor may pre-approve use of ACH or other second payment rail in some or all scenarios. The preference may be recorded in memory associated with the customer bank 112 or wallet server 106.

Using the above methodologies, both merchants and customers may save the cost of debit card expenses in certain situations. Financial institutions may offer systems and methods according to embodiments described herein as a service to both payor and payee clients. Payee clients may view these systems favorably as a product for reducing expenses and fraud. Payors may be attracted by incentives and discounts for granting permission for ACH transactions. Because ACH transactions take longer to clear, financial institutions may use some of the funds as a float, thus recuperating some transactional costs.

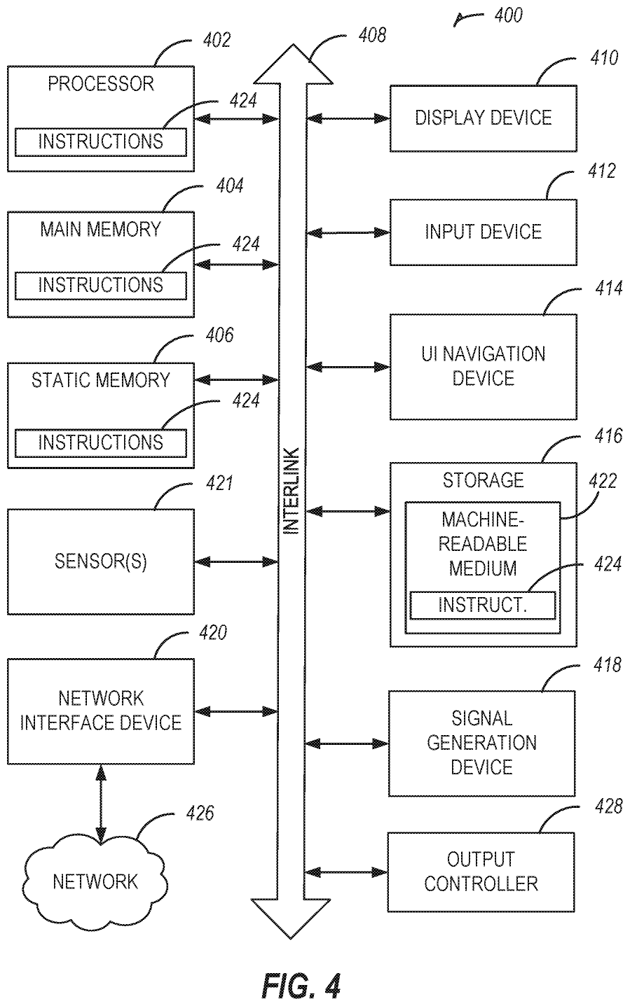

FIG. 4 illustrates generally an example of a block diagram of a machine 400 upon which any one or more of the techniques (e.g., methodologies) discussed herein may perform in accordance with some embodiments. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, alphanumeric input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 that is non-transitory on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), a legacy telephone network, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method for processing a transaction, the method comprising:
receiving a request, from a wallet application, to perform a transaction to transfer funds from a payor account over a first payment rail, the first payment rail being associated with a payment network corresponding with an element of the wallet application;
determining whether a second payment rail is available for processing the request based upon a determination that the second payment rail meets a requirement of the transaction, the second payment rail having at least a reduced processing cost relative to the first payment rail; and
upon determining that the second payment rail is available, converting the request to a request for processing using a second payment rail different from the first payment rail, and processing the request using the second payment rail.

2. The method of claim 1, wherein the second payment rail includes an automated clearing house (ACH) system and wherein the requirement of the transaction includes a timing requirement.

3. The method of claim 1, wherein the reduced processing cost includes financial network fees.

4. The method of claim 1, wherein the request includes a request to process the transaction using a debit card system payment rail.

5. The method of claim 4, wherein the debit card system payment rail is associated with a direct deposit account associated with the payor account.

6. The method of claim 5, wherein determining whether the second payment rail is available for processing the request comprises determining identification information for account holders of the direct deposit account.

7. The method of claim 6, wherein determining whether the second payment rail is available for processing the request comprises predicting available funds of the direct deposit account.

8. The method of claim 7, wherein detecting likely available funds includes predicting at least one of a subsequent direct deposit date or a subsequent direct deposit amount.

9. The method of claim 6, wherein determining whether the second payment rail is available for processing the request comprises predicting whether the request is involves a product that is likely to be returned or disputed by a payor associated with the payor account.

10. The method of claim 1, comprising:
providing a user interface request to request approval from a payor associated with the payor account to use the second payment rail.

11. The method of claim 10, comprising:
requesting approval from a payee to use the second payment rail; and
upon receiving approval from the payee, process the request using the second payment rail.

12. The method of claim 10, comprising:
providing a reward to the payor subsequent to using the second payment rail to process the request.

13. The method of claim 1, comprising:
registering a wallet with the payor account; and
recording a payor account preference for one of the first payment rail and at least the second payment rail.

14. The method of claim 1, wherein the request is received from a wallet.

15. A system for processing a transaction, the system comprising:
a network interface for receiving a request, from a wallet application, to perform a transaction to transfer funds from a payor account over a first payment rail; and
a processor coupled to the network interface, the processor configured to:
determine whether a second payment rail having a reduced processing cost relative to the first payment rail is available for processing the request based upon a determination that the second payment rail meets a requirement of the transaction;
upon determining that the second payment rail is available:
convert the request to a request for processing using a second payment rail different from the first payment rail; and
process the request using the second payment rail.

16. The system of claim 15, wherein the second payment rail includes an automated clearing house (ACH) system.

17. The system of claim 15, wherein the first payment rail is associated with a debit account associated with the payor account, and wherein the processor is configured to determine whether the second payment rail is available for processing the request by:
determining identification information for account holders of the payor account; and
predicting available funds of the debit account at least one of a subsequent direct deposit date or a subsequent direct deposit amount.

18. The system of claim 15, further comprising a user interface configured to display a request for approval to process the request using the second payment rail.

19. A non-transitory computer-readable medium including instructions that, when executed on a processor, cause the processor to perform operations including:
receiving a request, from a wallet application, to perform a transaction to transfer funds from a payor account over a first payment rail;
determining whether a second payment rail is available for processing the request based upon a determination that the second payment rail meets a requirement of the transaction, the second payment rail having a reduced processing cost relative to the first payment rail; and
upon determining that the second payment rail is available, converting the request to a request for processing using a second payment rail different from the first payment rail, and processing the request using the second payment rail.

20. The non-transitory computer-readable medium of claim 19, wherein:
the request includes a request to process the transaction using a debit card system payment rail for accessing a direct deposit account associated with the payor account;
determining whether the second payment rail is available for processing the request comprises:
determining identification information for account holders of the direct deposit account; and
predicting available funds of the direct deposit account.
